(19) United States
(12) Patent Application Publication
(10) Pub. No.: US 2008/0034179 A1
(43) Pub. Date: Feb. 7, 2008

(54) GUARD BANDS IN VERY LARGE VIRTUAL MEMORY PAGES

(76) Inventors: Greg R. Mewhinney, Austin, TX (US); Mysore Sathyanarayana Srinivas, Austin, TX (US)

Correspondence Address: IBM CORP (YA);C/O YEE & ASSOCIATES PC, P.O. BOX 802333, DALLAS, TX, 75380, US

(21) Appl. No.: 11/462,055

(22) Filed: Aug. 3, 2006

(51) Int. Cl. G06F 12/14

(52) U.S. Cl. 711/163

(57) ABSTRACT

A computer implemented method, apparatus, and computer usable program code for guarding data structures in a data processing system. An exemplary method includes establishing a first guard address range in a portion of a first virtual memory page associated with the data processing system. The portion is less than the entirety first virtual memory page. Responsive to an attempt to access the first guard address range, a storage exception signal is generated.

### BACKGROUND OF THE INVENTION

1. Field of the Invention

The present invention relates generally to an improved data processing system and in particular to managing large virtual memory pages.

2. Description of the Related Art

In multi-processing processor architectures, physical and virtual memory are used to execute programs and to manipulate data. Physical memory refers to memory in the form of a purely physical device, such as on a computer chip or a hard drive. As used herein, physical memory primarily refers to chip-based memory such as dynamic random access memory (DRAM) and static random access memory (SRAM), but can refer to other forms of physical memory such as a hard drive. Virtual memory, or virtual memory addressing, is a memory management technique, used by multitasking computer operating systems, wherein non-contiguous memory is presented to a software application as contiguous memory. The contiguous memory is referred to as the virtual address space. Virtual memory allows software to run in a memory address space whose size and addressing are not necessarily tied to the computer's physical memory. Thus, virtual memory allows some of the data contained in a computer's volatile memory (such as random access memory) to be stored temporarily on a hard disk in order to allow more data and programs to operate at the same time. Without virtual memory, a computer could not operate as many programs or hold as much data at the same time.

In some processor architectures, both physical memory and virtual memory can be logically divided into data structures known as memory pages. A physical memory page is a memory page in physical memory, and a virtual memory page is a memory page in virtual memory. Each kind of memory page has associated with it a page table entry (PTE). A page table entry contains data that allows mapping a virtual page number to a physical page number. A page table is a collection of page table entries. The page table entries allow a processor to track where memory pages are located so that the processor can access data as needed or desired. The exact organization and content of memory pages and page table entries can vary.

In some processor architectures, translations between a virtual page number and a physical page number are also contained in a page table entry. In these architectures, the processor searches the page table when a translation for a particular virtual address is requested.

However, accessing and searching the entire page table can be relatively time-consuming. Thus, page table entries may be stored in a cache. In the some processor architectures, page table entries are stored in a cache known as a translation lookaside buffer (TLB). Because page table entries are allocated one per virtual memory page, larger page sizes will allow more data to be translated per page table entry. The term “larger” is a relative term describing the memory size of a page in relation to many known smaller page sizes. A “large” page size has a size that is more than about a thousand kilobytes, though typically a “large” page is sixteen megabytes or more. A “small” or “smaller” page size is less than about a thousand kilobytes, though typically a “small” or “smaller” page size is only a few kilobytes or smaller. Larger pages can therefore provide a performance benefit for programs that access a large amount of data by increasing the chances of successfully finding a desired page table entry in the cache.

In addition, a certain class of applications benefit from having a “guard page” placed between valid data pages in a processor's virtual address space. Guard pages allow an application to be notified, via a processor storage exception, if a program attempts to access memory beyond a valid page. A known application of guard pages is to protect critical data structures in data storage devices.

Large memory pages can be used as guard pages. In practice, however, large memory pages are not used as guard pages because in some cases only a few kilobytes are needed for the protected data structure, but a large memory page may consume many megabytes. In other words, data structures on a used data page tend to be small such that the remainder of a large data page would be wasted. As a result, a vast amount of memory would be wasted when using this class of applications. For this reason, only small memory pages are used as guard pages. However, small memory pages do not have the performance of large memory pages, as described above.

### SUMMARY OF THE INVENTION

The illustrative examples provide a computer implemented method, apparatus, and computer usable program code for guarding data structures in a data processing system. An exemplary method includes establishing a first guard address range in a portion of a first virtual memory page associated with the data processing system. The portion is less than the entire first virtual memory page. Responsive to an attempt to access the first guard address range, a storage exception signal is generated.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the aspects of the illustrative embodiments may be implemented;

FIG. 2 is a block diagram of a data processing system in which aspects of the illustrative embodiments may be implemented;

FIG. 3 is a block diagram showing a representation of a processor virtual address space, in accordance with an illustrative embodiment;

FIG. 4 is a block diagram showing a representation of translating a virtual page number to a real page number, in accordance with an illustrative embodiment;

FIG. 5 is a block diagram showing a representation of a processor virtual address space, in accordance with an illustrative embodiment;

FIG. 6 is a block diagram showing a representation of a processor virtual address space in which guard bands are implemented, in accordance with an illustrative embodiment;

FIG. 7 is a block diagram showing a representation of an effective address, in accordance with an illustrative embodiment;

FIG. 8 is a block diagram of the effective address shown in FIG. 7 translated into a representation of a physical address, in accordance with an illustrative embodiment;

FIG. 9 is a block diagram of a representation of a page offset in a physical address, in accordance with an illustrative embodiment;

FIG. 10 is a block diagram of a representation of a page offset in a physical address, in accordance with an illustrative embodiment;

FIG. 11 is a block diagram of a large virtual page segmented into usable bands and guard bands, in accordance with an illustrative embodiment;

FIG. 12 is a flowchart illustrating memory access in a data processing system, in accordance with an illustrative embodiment;

FIG. 13 is a flowchart illustrating memory access in a data processing system using guard bands, in accordance with an illustrative embodiment; and

FIG. 14 is a flowchart illustrating establishment and use of a guard address range in a virtual memory page, in accordance with an illustrative embodiment.

### DETAILED DESCRIPTION OF THE PREFERRED EMBODIMENT

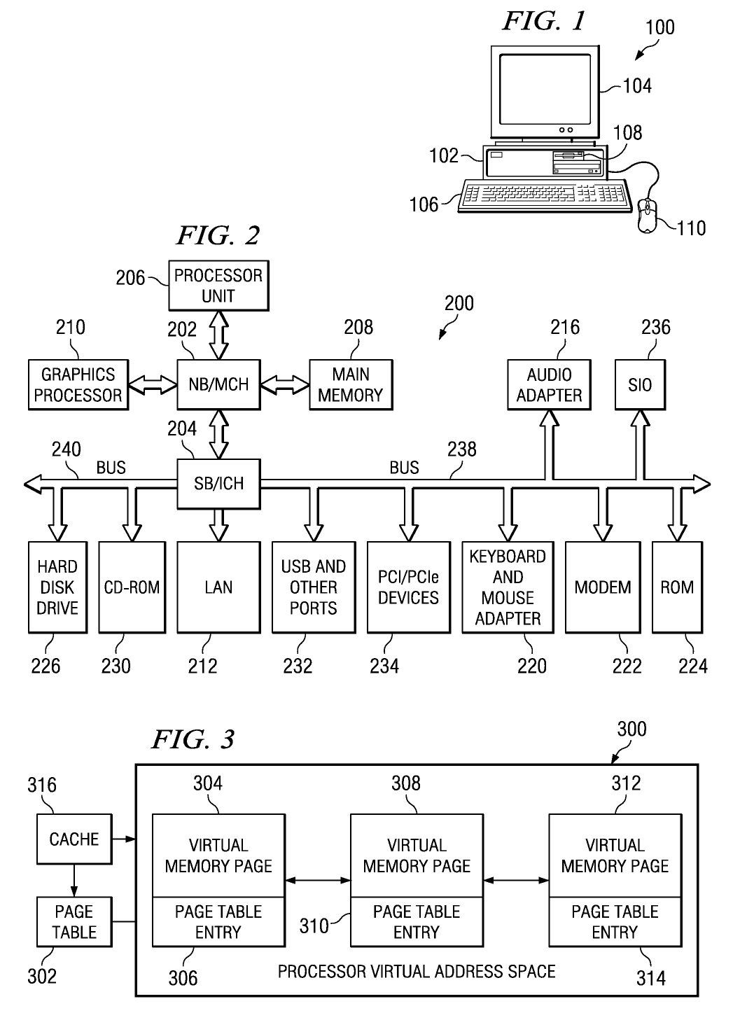

With reference now to the figures and in particular with reference to FIG. 1, a pictorial representation of a data processing system is shown in which the illustrative embodiments may be implemented. Computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 may be any suitable computer, such as an IBM® eServer™ computer or IntelliStation® computer, which are products of International Business Machines Corporation, located in Armonk, N.Y. Although the depicted representation shows a personal computer, other embodiments may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which illustrative embodiments may be implemented. Data processing system 200 is an example of a computer, such as computer 100 in FIG. 1, in which code or instructions implementing the processes for the illustrative embodiments may be located. In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The depicted embodiments provide for a computer implemented method, apparatus, and computer usable program code for compiling source code. The methods in the illustrative examples may be performed in a data processing system, such as data processing system 100 shown in FIG. 1 or data processing system 200 shown in FIG. 2.

The illustrative embodiments provide a computer implemented method, apparatus, and computer usable program code for guarding data structures in a data processing system, such as data processing system 100 in FIG. 1 and data processing system 200 in FIG. 2. An exemplary method includes establishing a first guard address range in a portion of a first virtual memory page associated with the data processing system. The portion is less than the entire first virtual memory page. Thus, the portion has a size that is smaller than the size of the first virtual memory page. Responsive to an attempt to access the first guard address range, a storage exception signal is generated.

Thus, a virtual memory page is divided up into guard bands and usable bands such that an application can gain the benefits of guard pages and also simultaneously gain the benefits of using large memory pages. As explained in more detail below, a guard band is a guard address range within a memory page. In contrast, a guard page allows an application to be notified, via a processor storage exception, if a program attempts to access memory beyond a valid page. Thus, a guard band exists within a memory page, whereas a guard page is an entire memory page.

FIG. 3 is a block diagram showing a representation of a processor virtual address space, in accordance with an illustrative embodiment. Processor virtual address space 300 is located in a memory of a data processing system. For example, processor virtual address space 300 can exist in processor unit 206, main memory 208, or hard disk 226 in FIG. 2, which itself is a representation of data processing system 100 in FIG. 1.

Processor virtual address space 300 includes one or more virtual memory pages, such as virtual memory page 304, virtual memory page 308, and virtual memory page 312. As explained in the background, a virtual memory page is a logical partition of virtual memory in a data processing system. Virtual memory is a memory management technique, used by multitasking computer operating systems, wherein non-contiguous memory is presented to a software application as contiguous memory.

In addition, a page table entry is a part of each virtual memory page. A page table entry contains data that allows mapping a virtual page number to a physical page number. Thus, page table entry 306 is associated with virtual memory page 304, page table entry 310 is associated with virtual memory page 308, and page table entry 314 is associated with virtual memory page 312. Each kind of memory page has associated with it a page table entry (PTE) that maps a page number to a page table entry. A processor can access different virtual memory pages via mapping of page table entries such that the processor can access data from one virtual page in relation to another virtual page, as indicated by the arrows shown in FIG. 3.

Page table 302 is also associated with processor virtual address space 300. Page table 302 is a collection of page table entries. Page table 302 can be stored in a data structure located in any convenient memory location. The page table entries allow a processor to track where memory pages are located so that the processor can access data as needed or desired. The exact organization and content of memory pages and page table entries can vary depending on the implementation.

In this illustrative example, translations between a virtual page number and a physical page number are contained in a page table entry. Thus, the processor can search page table 302 when a translation for a particular virtual address is requested.

However, accessing and searching the entire page table can be relatively time-consuming. Thus, page table entries may be stored in a cache, such as cache 316. In some processor architectures, page table entries can be stored in a cache known as a translation lookaside buffer (TLB). Because page table entries are allocated one per virtual memory page, as shown in FIG. 3, larger page sizes will allow more data to be translated per page table entry. Larger pages can therefore provide a performance benefit for programs that access a large amount of data by increasing the chances of successfully finding a desired page table entry in cache 316.

The term “larger” is a relative term describing the memory size of a page in relation to many known smaller page sizes. A “large” page size has a size that is more than about a thousand kilobytes, though typically a “large” page is sixteen megabytes or more. A “small” or “smaller” page size is less than about a thousand kilobytes, though typically a “small” or “smaller” page size is only a few kilobytes or smaller.

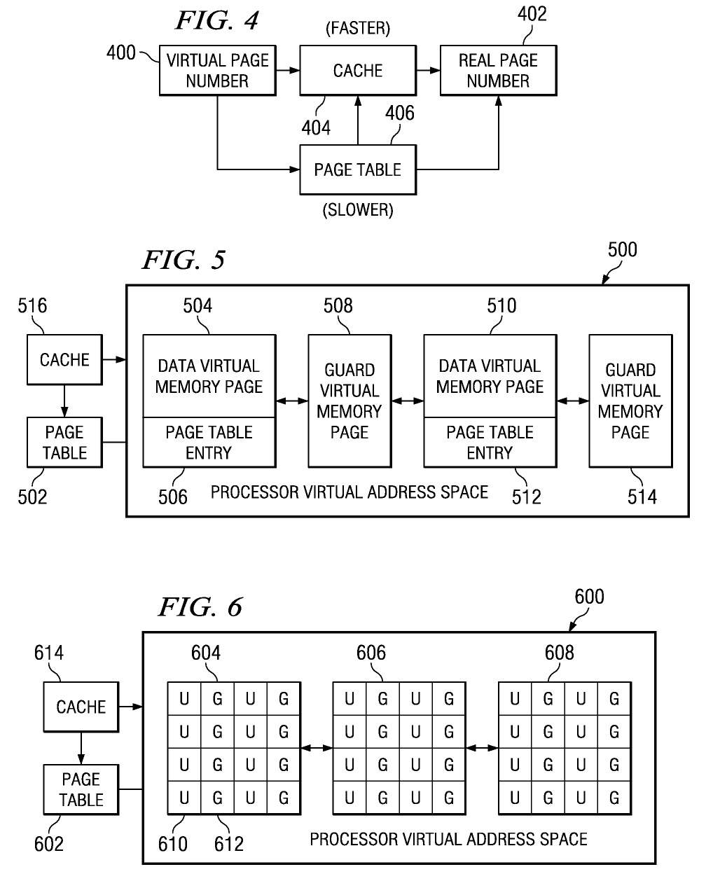

FIG. 4 is a block diagram showing a representation of translating a virtual page number to a real page number, in accordance with an illustrative embodiment. The process illustrated in FIG. 4 can be implemented in processor virtual address space 300 in FIG. 3, which in turn is established in data processing system 100 of FIG. 1 or data processing system 200 of FIG. 2. Cache 404 corresponds to cache 316 of FIG. 3 and page table 406 corresponds to page table 302 of FIG. 3.

In the illustrative example shown, a processor is instructed to translate virtual page number 400 to real page number 402 in order to access a desired virtual memory page. The processor can accomplish this task by either using page table 406 or cache 404. Page table 406 contains a complete list of all page table entries and page numbers, including all virtual page numbers and all real page numbers. While the processor should always be able to use page table 406 to perform the translation, the time required to search page table 406 can be more than desired.

For this reason, the data processing system is provided with cache 404. In an illustrative example, cache 404 is known as a translation lookaside buffer (TLB). Cache 404 contains all recently used page table entries and hence page numbers. In other illustrative examples, cache 404 contains commonly used page table entries and page numbers. In other illustrative examples, cache 404 contains selected page table entries and page numbers. In yet other illustrative examples, cache 404 can contain a combination of these types of information.

In any case, cache 404 contains fewer, usually far fewer, page tables entries and page numbers than page table 406. As a result, if a processor can locate virtual page number 400 and real page number 402 in cache 404, then the translation between virtual page number 400 and real page number 402 can proceed much more quickly than if page table 406 is used to perform the translation.

FIG. 5 is a block diagram showing a representation of a processor virtual address space, in accordance with an illustrative embodiment. Virtual address space 500 is similar to virtual address space 300 shown in FIG. 3, though virtual address space 500 illustrates the use of guard pages. Processor virtual address space 500 corresponds to processor virtual address space 300 shown in FIG. 3. Likewise, page table 502 and cache 516 in FIG. 5 correspond to page table 302 and cache 316 in FIG. 3. A processor can use page table 502 and cached 516 to perform memory address translation as shown in FIG. 4.

As explained in the background, some applications benefit from having a “guard page” placed between valid data pages in a processor's virtual address space. Guard pages allow an application to be notified, via a processor storage exception, if a program attempts to access memory beyond a valid page. A known application of guard pages is to protect critical data structures in data storage devices.

In the illustrative example shown in FIG. 5, guard virtual memory page 508 is inserted between data virtual memory page 504 and data virtual memory page 510. Similarly, guard virtual memory page 514 is inserted between data virtual memory page 510 and some other virtual memory page (not shown). Data virtual memory pages 504 and 510 contain data relevant to an application using processor virtual address space 500. Data virtual memory page 504 includes page table entry 506 and data virtual memory page 510 includes page table entry 512. Thus, data virtual memory page 504 and data virtual memory page 510 have the same structure as virtual memory pages 304, 308, and 312 in FIG. 3.

Guard virtual memory pages 508 and 514 prevent that application from accessing processor virtual address space 500 in an undesirable manner. In the illustrative example, if the application attempts to access memory beyond a valid page, guard virtual memory page 508 and guard virtual memory page 514 are setup such that the application would attempt to access guard virtual memory page 508 or guard virtual memory page 514. In the example, the valid page may be, for example, data virtual memory page 504 or data virtual memory page 510. However, the application cannot access the guard virtual memory pages. Thus, if the application attempts to access memory beyond a valid virtual memory page, then the processor sends a storage exception signal to the application. The application then handles the fault or error in whatever manner the application has been programmed to handle such a fault or error. In this manner, applications can be prevented from accessing critical data structures in data storage devices.

Guard virtual memory pages 508 and 514 can be large virtual memory pages or small virtual memory pages. A large virtual memory page can contain an amount of memory up to many megabytes of data. A small virtual memory page can contain an amount of memory up to less than a megabyte of data. In the illustrative example shown in FIG. 5, it is known to use small guard virtual memory pages in place of guard virtual memory page 508 and guard virtual memory page 514. However, in this case, data virtual memory page 504 and data virtual memory page 510 are also small virtual memory pages. The virtual memory pages are small virtual memory pages because the data structures that need to be protected by the guard virtual memory pages are likely relatively small and numerous. The term “small” refers to memory pages or data structures that are about several thousand kilobytes or smaller. The term “small” can also refer to memory pages that are data structures that are smaller than known “large” memory pages, as defined above.

Nevertheless, large memory pages can be used as guard pages. In practice, however, large memory pages are not used as guard pages because in some cases only a few kilobytes are needed for the protected data structure, but a large memory page may consume many megabytes. In other words, data structures on a used data page tend to be small such that the remainder of a large data page would be wasted. As a result, a vast amount of memory would be wasted when using this class of applications. For this reason, only small memory pages are used as guard pages. However, small memory pages do not have the performance of large memory pages, as described above.

FIG. 6 is a block diagram showing a representation of a processor virtual address space in which guard bands are implemented, in accordance with an illustrative embodiment. Processor virtual address space 600 is similar to processor virtual address space 300 of FIG. 3 and processor virtual address space 500 of FIG. 5 in that processor virtual address space 600 includes a number of virtual memory pages and is associated with a page table and a cache.

Specifically, processor virtual address space 600 includes, virtual memory page 604, virtual memory page 606, and virtual memory page 608, though more virtual memory pages could be included. Similarly, processor virtual address space 600 is associated with page table 602 and cache 614. Page table 602 is similar to page table 502 of FIG. 5 and page table 302 of FIG. 3. Likewise, cache 614 is similar to cache 516 of FIG. 5 and cache 316 of FIG. 3. Thus, the operation of page table 602 and cache 614 is similar to the corresponding operation shown in FIG. 5.

However, unlike the virtual memory pages shown in FIG. 3 and FIG. 5, each of virtual memory pages 604, 606, and 608 are segmented into a number of areas of alternating usable address ranges and guard address ranges. A usable address range in a virtual memory page is designated by the letter “U” in FIG. 6, such as usable address range 610. A usable address range can be referred to as a usable band. A guard address range in a virtual memory page is designated by the letter “G” in FIG. 6, such as guard address range 612. A guard address range can be referred to as a guard band. In contrast, a guard page allows an application to be notified, via a processor storage exception, if a program attempts to access memory beyond a valid page. Thus, a guard band exists within a memory page, whereas a guard page is an entire memory page.

Each usable address range provides an area to store data that an application can access. However, if an application attempts to access one of the guard address ranges, then the processor will send a storage exception signal to the application. The application, in turn, handles the exception or fault according to the programming of the application.

In the illustrative example shown in FIG. 6, each of virtual memory pages 604, 606, and 608 are large virtual memory pages, though they could be small virtual memory pages. Because virtual memory pages 604, 606, and 608 are large, the data processing system benefits from the performance benefits of using large virtual memory pages, as described above. However, because guard address ranges in the large virtual memory page prevent an application from erroneously accessing data, the data processing system also gains the benefits of using guard virtual memory pages—even though guard virtual memory pages are not used in processor virtual address space 600.

If the band size, or address range size, is chosen to be the same size as a typical small virtual memory page, then the large virtual memory page with guard bands would be indistinguishable to the application from a group of small data virtual memory pages and guard virtual memory pages, as shown in FIG. 5. Thus, the application would gain all of the benefits of using the configuration of virtual address space 500 of FIG. 5, and also gain all of the benefits of using large virtual memory pages as shown in FIG. 6.

In other illustrative examples, the band size, or address range size, of usable address ranges and guard address ranges is variable and can be set by the processor at a request by the application or by a user. The application requests that the operating system or software or hardware managing the memory management system configure the size of usable data address ranges and guard address ranges in each large virtual memory page. In contrast, current guard virtual memory pages are limited to available page size. Thus, the use of guard bands in large virtual memory pages creates flexibility for applications that did not previously exist.

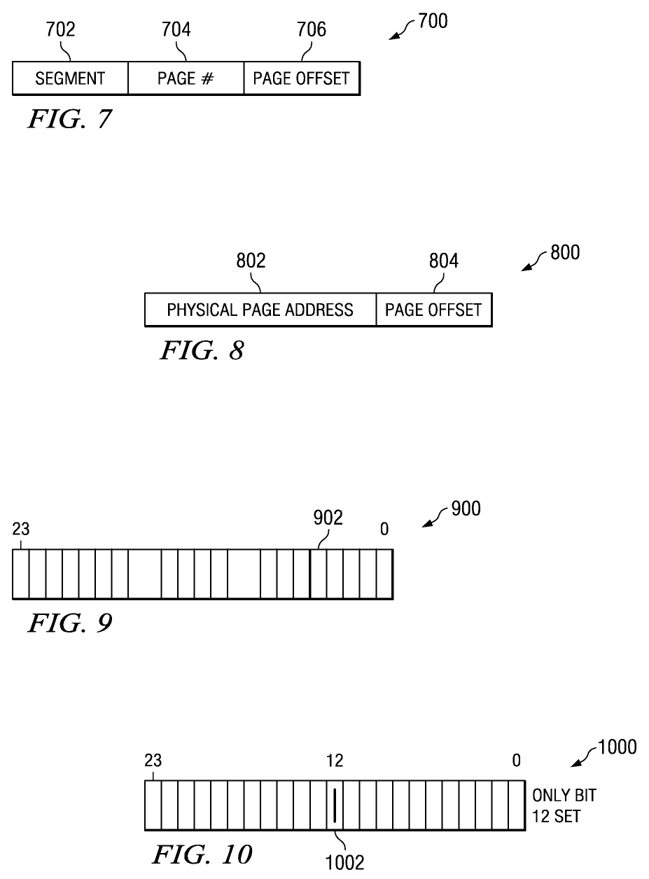

FIG. 7 through FIG. 11 illustrate in detail how guard bands or guard address ranges can be implemented in a large virtual memory page. FIG. 7 is a block diagram showing a representation of an effective address, in accordance with an illustrative embodiment. An effective address represents the relative location of a portion of memory in a data processing system. In an illustrative embodiment, the size of the portion is less than the size of the memory itself. The effective address can be an address for a real memory address or a virtual memory address. The effective address shown in FIG. 7 can be included as part of a page table entry associated with a virtual memory page, as described with respect to FIG. 3 and FIG. 5.

Effective address 700 can include three portions, such as segment 702, page number 704, and page offset 706. In this illustrative example, effective address 700 is a 64 bit address, but can be of a different size. Segment 702 contains the address number of a particular memory location. Page number 704 contains data regarding the virtual memory page associated with the particular memory location. Page offset 706 contains other information of use in tracking and manipulating the particular memory location. Using a cache or page table as described with respect to FIG. 4, a processor converts effective address 700 in FIG. 7 to physical address 800 shown in FIG. 8.

FIG. 8 is a block diagram of the effective address shown in FIG. 7 translated into a representation of a physical address, in accordance with an illustrative embodiment. Physical address 800 represents the relative location of a particular portion of memory in a physical memory system. Physical address 800 includes physical page address 802 and page offset 804. Physical page address 802 contains the address number of the particular portion of physical memory. Page offset 804 is unchanged during translation, so page offset 804 is the same as page offset 706 shown in FIG. 7.

FIG. 9 is a block diagram of a representation of a page offset in a physical address, in accordance with an illustrative embodiment. Thus, page offset 900 shown in FIG. 9 corresponds to page offset 804 in FIG. 8 and page offset 706 in FIG. 7. In the illustrative examples shown, virtual memory page has a size of 16 megabytes and page offset 706 has a typical size of 24 bits for this size virtual memory page. Thus, FIG. 9 shows each of the 24 bits available in page offset 900, where each bit is labeled from bit 0 to bit 23. Any particular cell, such as cell 902, is one bit.

FIG. 10 is a block diagram of a representation of a page offset in a physical address, in accordance with an illustrative embodiment. Page offset 1000 corresponds to page offset 900 in FIG. 9, page offset 804 in FIG. 8 and page offset 706 in FIG. 7. However, the bit in cell 1002 (cell 12) has been set to have the value of 1. The value of 1 can be referred to as “true” because the value of cell 1002 can only be 1 or 0. Hence, the value of 0 can be referred to as “false”.

In this illustrative example, effective address 700 lies on either a usable address range or on a guard address range. A processor can determine whether effective address 700 lies on the usable address range or on a guard address range using a bitmask.

A bitmask is some data that, along with an operation, are used in order to extract information stored elsewhere. A bitmask can be used, for example to extract the status of certain bits in a binary string or number. For example, in the binary string 100111010 a user desires to extract the status of the fifth bit, counting along from the most significant bit. A bitmask such as 000010000 could be used, along with an “AND” operator. Recalling that 1 “AND” 1=1, and that 1 “AND” 0 is 0, the status of the fifth bit can be determined. In this case, the bitmask extracts the value of the fifth bit in the first binary string, which is the number “1.”

Continuing the illustrative example, a processor uses a bitmask, which can be referred to as a guard bitmask, to determine the status of cell 1002 in page offset 900. The guard bitmask and page offset 900 are chosen and designed such that if cell 1002 is “true”, or has the value of “1,” then effective address 700 is a usable address. For example, the processor compares page offset 900 to the guard bitmask using an “AND” operation. If the result of the comparison results in cell 1002 having a value of “true,” then address 700 is in a usable range. However, if the result of the comparison results in cell 1002 having a value of “false,” or “0,” then the address range is in a guarded address range. In this case, the processor sends a storage exception to the application attempting to access guarded address 700.

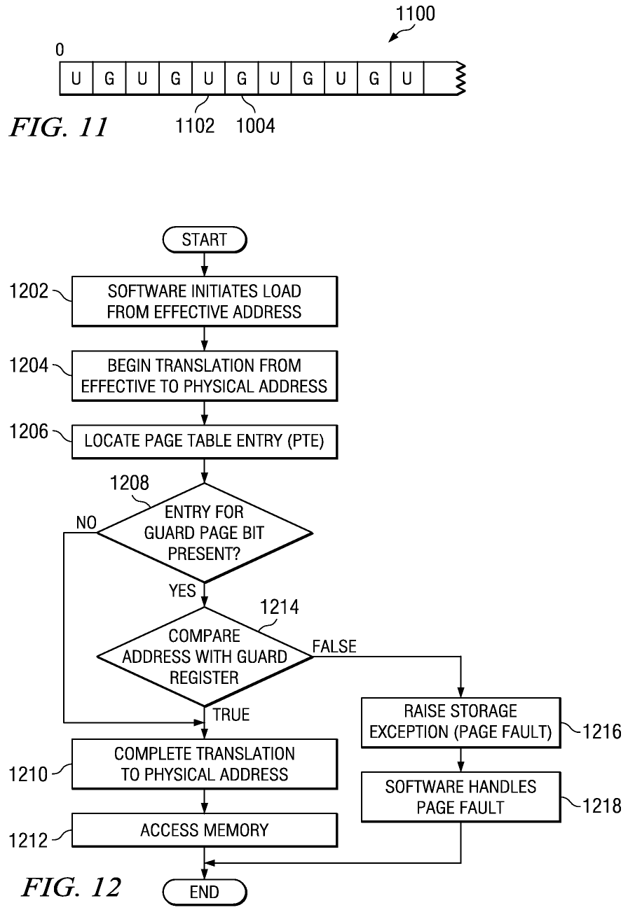

FIG. 11 is a block diagram of a large virtual page segmented into usable bands and guard bands, in accordance with an illustrative embodiment. Large virtual memory page 1100 includes a number of bands, such as band 1102 and band 1104. Each band represents a portion of memory within large virtual memory page 1100. In an illustrative embodiment, the size of the portion is less than the size of virtual memory page 1100. Each band has associated with it one or more effective addresses, such as effective address 700 shown in FIG. 7. In the illustrative example shown, large virtual memory page 1100 is divided into alternating usable bands and guard bands. For example, band 1102 is a usable band and band 1104 is a guard band.

By performing an “AND” operation with the address to which an application attempts access, large virtual memory page 1100 can be divided into usable bands and guard bands as shown. If the page offset of each address lies in a usable band, then the application has access to the corresponding portion of memory. On the other hand, if the page offset of an address lies in a guard band, then the processor sends a storage exception signal, as shown above. Thus, large virtual memory page 1100 can be divided into guard bands and virtual bands as shown. Similarly, large virtual memory pages 604, 606, and 608 shown in FIG. 6 and the large virtual memory pages shown in FIG. 3 and FIG. 5 can also be divided into guard bands and usable bands.

Described differently, information regarding bands can be stored at the segment level of an address and propagated to the mechanism that creates an effective to real address mapping. When the effective address that lies on a guard band is presented for translation, the effective address is compared to a guard bitmask using an “AND” operation. A single bit is present in the guard bitmask. If the result of the comparison is “true,” then a storage exception will be raised and communicated to the application attempting to access the memory area. If the result of the comparison is “false,” then the address lies within a usable band and the application can access the portion of memory corresponding to the effective address.

The particular bit chosen in the page offset of the effective address will set the desired size of guard bands and usable bands. Thus, the size of guard bands and usable bands in a large virtual memory page can be varied and changed by a user, the processor, the operating system, or the application using the guard band feature. For example, if a 4 kilobyte band size is desired, then bit 12 in the guard bitmask would be set to have the value of “1”.

The method of determining whether a band is a guard band or a usable band can be varied from the method described above. Another illustrative example for performing this determination is to use the bitmask to compare all access to memory, setting up the bitmask just prior to the comparison. Another illustrative example is to perform the bitmask comparison on a known guard band.

In an illustrative example, the size of a guard band is limited to size equal to a multiple of a traditional small virtual memory page. Even though address ranges of guard bands can not be accessed, virtual memory pages are contiguous in physical memory. Thus, memory will be wasted in the address ranges of the guard bands. However, if guard band sizes are a multiple of existing small virtual memory page sizes, then the physical memory that would otherwise be wasted could be mapped as smaller virtual memory pages. Thus, no additional waste of memory can occur if guard band sizes are integral multiples of the sizes of small virtual memory pages.

FIG. 12 is a flowchart illustrating memory access in a data processing system, in accordance with an illustrative embodiment. The process shown in FIG. 12 can be implemented in a data processing system, such as data processing system 100 in FIG. 1 and data processing system 200 in FIG. 2. The process shown in FIG. 12 can also be implemented with respect to a processor virtual address space having guard virtual memory pages, such as processor virtual address space 500 shown in FIG. 5. Additionally, translation of virtual page numbers to real page numbers can be accomplished as described in FIG. 4. A processor, such as processor 206 in FIG. 2, can perform the translation.

The process begins as a software application attempts to initiate loading data from a portion of memory located at a particular effective address (step 1202). A processor begins to translate the effective address, which is a virtual address, to a physical address (step 1204). As part of that translation process, the processor locates a page table entry for the effective address and the physical address (step 1206).

The processor then determines whether an entry for a guard page bit is present (step 1208). Responsive to a determination that the entry for the guard page bit is not present, the processor completes the translation from the virtual address to the physical address (step 1210). The software application then accesses the portion of memory at the physical address (step 1212), with the process terminating thereafter.

Responsive to a determination that the entry for the guard page bit is present, the processor compares the effective address with a guard register (step 1214). If the comparison has a “true” result, then the virtual memory page being accessed is a usable virtual memory page. As a result, the process continues to steps 1210 and 1212 as described above.

On the other hand, if the comparison at step 1214 has a “false” result, then the processor raises a storage exception and transmits an exception signal or a page fault signal to the software application attempting to access the virtual memory page (step 1216). At that point, the software application handles the page fault according to its programming (step 1218), with the process terminating thereafter.

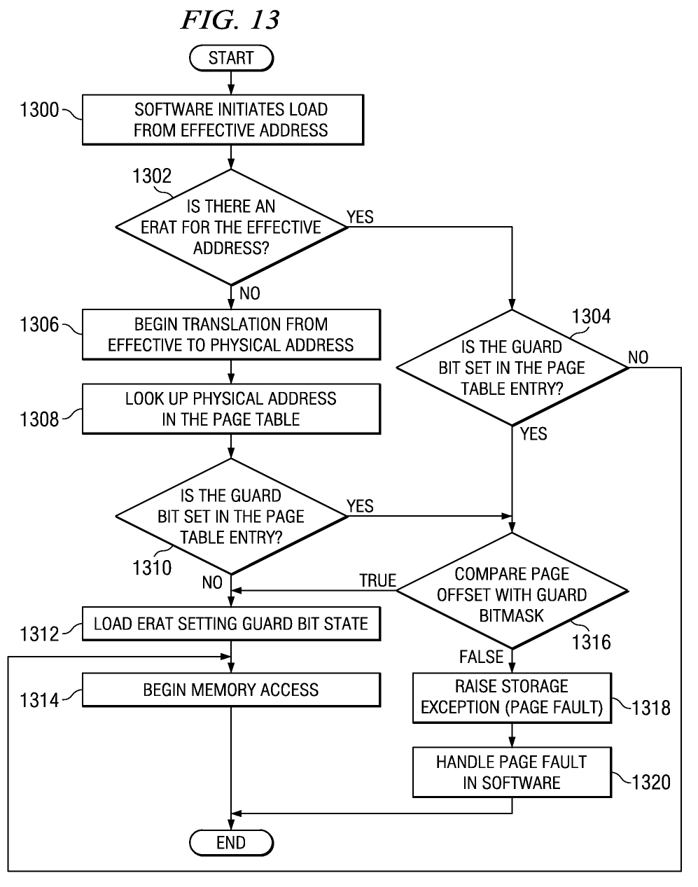

FIG. 13 is a flowchart illustrating memory access in a data processing system using guard bands, in accordance with an illustrative embodiment. The process shown in FIG. 13 can be implemented in a data processing system, such as data processing system 100 in FIG. 1 and data processing system 200 in FIG. 2. The process shown in FIG. 13 can also be implemented with respect to a processor virtual address space, such as processor virtual address space 600 shown in FIG. 6 or processor virtual address space 300 shown in FIG. 3. Additionally, translation of virtual page numbers to real page numbers can be accomplished as described in FIG. 4. A processor, such as processor 206 in FIG. 2, can perform the translation. Thus, FIG. 13 represents a method of using guard bands as described with respect to FIG. 6. The process shown in FIG. 13 is applicable to a variety of processor architectures.

The process begins in the same manner as the process in FIG. 12. First, a software application attempts to initiate loading data from a portion of memory located at a particular effective address (step 1302). However, next the processor determines whether an effective to real address mapping (ERAT) exists for the effective address (step 1302). Responsive to a determination that an effective to real address mapping exists for the effective address, a determination is made whether the guard bit is set in the page table entry (step 1304). If the guard bit is not set in the page table entry, then the processor allows the application to begin access to the portion of memory at the physical address (step 1314).

However, if the guard bit is set in the page table entry, then the processor compares the page offset with that of the effective address with a guard bitmask (step 1316). If the result of the comparison is “true”, then the processor loads the effective to real address mapping setting for the guard bit state (step 1312). Thereafter, the processor allows the software application to begin access to the portion of memory (step 1314), with the process terminating thereafter.

Returning to step 1316, if the result of the comparison of the page offset with the guard bitmask is “false”, then the processor raises a storage exception, or page fault, and transmits a signal to the application that the storage exception has been raised (step 1318). The software application handles the page fault according to its programming (step 1320), with the process terminating thereafter.

Returning to step 1302, if the processor determines that an effective to real address mapping does not exist for the effective address, then the processor begins translation from the effective address, or virtual address, to the physical address (step 1306). The processor then searches a page table for the physical address (step 1308). The processor then makes a determination whether the guard bit is set in the page table entry for the effective address (step 1310).

If the guard bit is not set in the page table entry, then the processor loads the effective to real address mapping setting for the guard bit state (step 1312). Thereafter the processor allows the software application to being accessing the portion of memory associated with the physical address (step 1314), with the process terminating thereafter.

On the other hand, if the guard bit is set in the page table entry at step 1310, then the processor compares the page offset with that of the effective address with a guard bitmask (step 1316). If the result of the comparison is “true”, then the processor loads the effective to real address mapping setting for the guard bit state (step 1312). Thereafter, the processor allows the software application to begin access to the portion of memory (step 1314), with the process terminating thereafter.

However, if the result of the comparison of the page offset with the guard bitmask is “false” at step 1316, then the processor raises a storage exception, or page fault, and transmits a signal to the application that the storage exception has been raised (step 1318). The software application handles the page fault according to its programming (step 1320), with the process terminating thereafter.

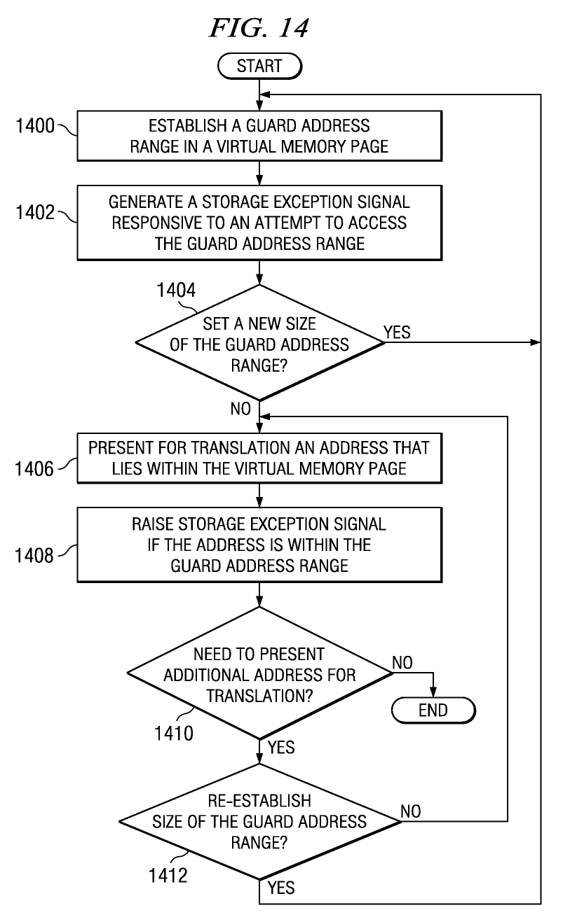

FIG. 14 is a flowchart illustrating establishment and use of a guard address range in a virtual memory page, in accordance with an illustrative embodiment. The process shown in FIG. 14 can be implemented in a data processing system, such as data processing system 100 in FIG. 1 and data processing system 200 in FIG. 2. The process shown in FIG. 14 can also be implemented with respect to a processor virtual address space, such as processor virtual address space 600 shown in FIG. 6 or processor virtual address space 300 shown in FIG. 3. A processor, such as processor 206 in FIG. 2, can perform the translation. Additionally, translation of virtual page numbers to real page numbers can be accomplished as described in FIG. 4.

The process begins as a processor, application, or user establishes a guard address range in a virtual memory page (step 1400). If an application, processor, or other software or hardware later attempts to access the guard address range then, responsive to the attempt, the processor generates a storage exception signal (step 1402). The processor can transmit the storage exception signal to an application or to hardware attempting to access the guard address range. The application handles the storage exception according to its programming and hardware handles the exception according to its design. Later, if desired, the processor, application, or user then determines whether to set a new size of the guard address range (step 1404). The decision is made according to the desires of the user or the needs or preferred operating modes of the application. If a new size of the guard address range is set, then the process returns to step 1400.

On the other hand, if no new size for the guard address range is set, then the processor presents for translation an address that lies within the virtual memory page (step 1406). The processor raises a storage exception signal if the address is within the guard address range (step 1408).

The processor then determines whether to present an additional address for translation (step 1410). If no additional address is to be translated, then the process terminates. On the other hand, if another address is to be translated, then the processor, application, or user determines whether to re-establish or change the size of the guard address range (step 1412). If the size of the guard address range is to be re-established or changed, then the process returns to step 1400 and repeats. Otherwise, if the size of the guard address range is not re-established or changed, then the process returns to step 1406, where the processor presents for translation an address that lies within the virtual memory page. The process then continues to repeat until eventually no additional address is to be presented for translation at step 1410, whereupon the process terminates.

The illustrative embodiments described herein provide a computer implemented method, apparatus, and computer usable program code for guarding data structures in a data processing system. An exemplary method includes establishing a first guard address range in a portion of a first virtual memory page associated with the data processing system. The size of the portion is less than the size of the entire first virtual memory page. Responsive to an attempt to access the first guard address range, a storage exception signal is generated.

The illustrative embodiments described herein have several advantages over known methods of implementing guard functions in a processor virtual address space. For example, by dividing a virtual memory page into guard bands and usable bands an application can gain the benefits of guard virtual memory pages and also simultaneously gain the benefits of using large memory pages. In other words, an application can gain the benefit of guard virtual memory pages even though guard virtual memory pages are not used in the processor virtual address space.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for guarding data structures in a data processing system, the computer implemented method comprising:
establishing a first guard address range in a portion of a first virtual memory page associated with the data processing system, wherein the portion comprises less than the entire first virtual memory page; and
responsive to an attempt to access the first guard address range, generating a storage exception signal.

2. The computer implemented method of claim 1 further comprising:
establishing the first guard address range between usable address ranges in the first virtual memory page.

3. The computer implemented method of claim 1 further comprising:
establishing a plurality of additional guard address ranges in a plurality of additional portions of the first virtual memory page such that the plurality of additional guard address ranges alternate in between a plurality of usable address ranges.

4. The computer implemented method of claim 1 further comprising:
setting a size of the first guard address range to be equal to a size of a second virtual memory page, wherein the size of the second virtual memory page is less than the size of the first virtual memory page.

5. The computer implemented method of claim 4 wherein the step of setting the size of the first guard address range is performed by an application.

6. The computer implemented method of claim 5 further comprising:
setting a second size of the first guard address range.

7. The computer implemented method of claim 1 further comprising:
setting a size of the first guard address range to be a multiple of a size of a second virtual memory page, wherein the size of the second virtual memory page is less than the size of the first virtual memory page.

8. The computer implemented method of claim 1 further comprising:
presenting for translation an address that lies within the first virtual memory page;
responsive to the address being within the first guard address range, generating the storage exception signal.

9. The computer implemented method of claim 1 wherein the first guard address range comprises a guard band.

10. A computer program product comprising:
a computer usable medium having computer usable program code for guarding data structures in a data processing system, the computer program product including:
computer usable program code for establishing a first guard address range in a portion of a first virtual memory page associated with the data processing system, wherein the portion comprises less than the entire first virtual memory page; and
computer usable program code for, responsive to an attempt to access the first guard address range, generating a storage exception signal.

11. The computer program product of claim 10 further comprising:
computer usable program code for establishing the first guard address range between usable address ranges in the first virtual memory page.

12. The computer program product of claim 10 further comprising:
computer usable program code for setting a size of the first guard address range to be equal to a size of a second virtual memory page, wherein the size of the second virtual memory page is less than the size of the first virtual memory page.

13. The computer program product of claim 12 wherein the computer usable program code for setting the size of the first guard address range comprises an application.

14. The computer program product of claim 13 further comprising:
computer usable program code for setting a second size of the first guard address range.

15. The computer program product of claim 10 further comprising:
computer usable program code for setting a size of the first guard address range to be a multiple of a size of a second virtual memory page, wherein the size of the second virtual memory page is less than the size of the first virtual memory page.

16. The computer program product of claim 10 further comprising:
computer usable program code for presenting for translation an address that lies within the first virtual memory page;
computer usable program code for, responsive to the address being within the first guard address range, generating the storage exception signal.

17. A data processing system comprising:
a processor;
a bus connected to the processor;
a computer usable medium connected to the bus, wherein the computer usable medium contains a set of instructions, wherein the processor is adapted to carry out the set of instructions to:
establish a first guard address range in a portion of a first virtual memory page associated with the data processing system, wherein the portion comprises less than the entire first virtual memory page; and
generate a storage exception signal, responsive to an attempt to access the first guard address range.

18. The data processing system of claim 17 wherein the processor is further adapted to carry out the set of instructions to:
establish the first guard address range between usable address ranges in the first virtual memory page.

19. The data processing system of claim 17 wherein the processor is further adapted to carry out the set of instructions to:
set a size of the first guard address range to be equal to a size of a second virtual memory page, wherein the size of the second virtual memory page is less than the size of the first virtual memory page.

20. The data processing system of claim 19 wherein the processor is further adapted to carry out the set of instructions to set the size of the first guard address range using an application.
